(19) United States
(12) Patent Application Publication
(10) Pub. No.: US 2004/0198322 A1
(43) Pub. Date: Oct. 7, 2004

(54) Method and system for session management of short message service enabled applications

(75) Inventor: David Edward William Mercer, Bothell, WA (US)

Correspondence Address: MERCHANT & GOULD PC, P.O. BOX 2903, MINNEAPOLIS, MN, 55402-0903, US

(73) Assignee: InfoSpace, Inc., Bellevue, WA

(21) Appl. No.: 10/121,844

(22) Filed: Apr. 12, 2002

(51) Int. Cl. H04M 11/10

(52) U.S. Cl. 455/412.1; 455/414.1

(57) ABSTRACT

The invention is directed to a method and system for managing a session of SMS messages between a service provider and a mobile device. An SMS message sent by a service provider includes a session key, such as a cookie, and the addresses for the mobile device and the service provider. An SMS gateway replaces the service provider's address in the SMS message with another address assigned to the gateway and stores the session key in a database. The modified SMS message is forwarded to the mobile device. When the mobile device replies to the modified SMS message and a timestamp has not expired, the SMS gateway replaces the other address provided by the gateway with the service provider's address and adds the session key to the modified SMS reply. The modified SMS reply and the Cookie is then forwarded to the service provider for processing.

### FIELD OF THE INVENTION

The present invention relates to the transmission of Short Message Service (SMS) communications over a mobile network. More particularly, the present invention relates to managing a session of SMS messages between a mobile device and a service provider.

### BACKGROUND OF THE INVENTION

Short Message Service (SMS) is a wireless messaging service intended for use on mobile networks. SMS enables the transmission of relatively brief text messages between mobile devices, fax machines and/or internet protocol (IP) addresses. SMS text messages of no more than 160 alphanumeric characters in length can be sent and received over mobile networks. SMS is considered an alternative to conventional paging services, and it is often used for communication in a session between the user of a mobile device and a value added service provider (VAS). For example, an SMS message initiated by a mobile device can include a request for information from a VAS such as stock quotes, account information and airline schedules. A response from the VAS can be communicated to the mobile device in another SMS message. In another example, a VAS may initiate a session of SMS messages by sending a message to the mobile device that includes advertisements, coupons or special announcements. In yet another example, a session of SMS messages can be employed for communication in a chat room or game.

In the past, SMS messages communicated between mobile devices and VASs have been stateless and asynchronous. For example, SMS messages have been asynchronously pushed to a destination address with no mechanism to relate a “pull” request (reply) to an SMS message that was previously pushed to the destination address. In particular, when a user of a mobile device wished to reply to the content of an SMS message sent by a VAS, a destination address and lengthy descriptive text relating to the content of the previously received SMS message had to be entered/hand coded in the reply. Thus, a mechanism for retaining “session” information for SMS messages between a VAS and a mobile device could reduce the amount of effort for a user to reply to an SMS message.

### SUMMARY OF THE INVENTION

The invention is directed to managing a session of communication between a service provider and a mobile device. A mobile terminated (MT) message and a session key is sent from the service provider to the mobile device; the MT message includes an address for the mobile device and an address for the service provider. The MT message is modified by replacing the service provider address with another address. The modified MT message is sent to the mobile device. When the mobile device provides a mobile originated (MO) reply to the modified MT message, the MO reply is modified by replacing the other address with the address of the service provider that was included in the unmodified MT message. The modified MO reply and the session key are sent to the service provider, where the modified MO reply is processed in relation to information included with the session key.

Another aspect of the invention is directed to storing the address of the service provider and the address of the mobile device as a tuple in a database. The other address and the address of the mobile device that are included in the mobile device's MO reply are used to access the tuple in the database. The service provider's address associated with the tuple is employed to modify the MO reply by replacing the other address with the address of the service provider.

Yet another aspect of the invention is directed to including a timestamp with the MT message sent by the service provider. The timestamp is associated with the tuple in the database. When the timestamp associated with the tuple is unexpired, the modified MO reply is sent to the service provider. Also, the period of time associated with the time stamp can be selected.

Still another aspect of the invention is directed to modifying a subsequent MT message by replacing the address of the service provider with one of a plurality of addresses that are each different than the other address used to replace the service provider's address in the previous MT message when the timestamp associated with a previous MT message is unexpired.

Another aspect of the invention is directed to providing a gateway to provide the other address that is employed to replace the address of the service provider in the modified MT message. Further, the plurality of addresses can be associated with the gateway. Also, the database may be managed by the gateway.

Yet another aspect of the invention is directed to associating the session key with a tuple and storing the session key in the database. Also, the session key can be a Cookie that includes session information.

Still another aspect of the invention is directed to employing a short messaging service (SMS) protocol for each MT message and each MO reply sent between the service provider and the mobile device.

Yet still another aspect of the invention is directed to forwarding the modified MT message from a gateway to a messaging center that handles sending the modified MT message to the mobile device. The MO reply can be received at a messaging center. Also, the other address included in the MO reply can be employed to identify a gateway. Further, the MO reply can be sent from the messaging center to the identified gateway.

Another aspect of the invention is directed to displaying a menu provided by the modified MT message with the mobile device; and when an item on the menu is selected, generating the MO reply.

Yet another aspect of the invention is directed to displaying at least a portion of the modified MT message with the mobile device; and when a keyword is entered, generating the MO reply. Additionally, the MO message and the session key can be included in an XML data structure posted by the service provider.

These and other features as well as advantages, which characterize the invention, will be apparent from a reading of the following detailed description and a review of the associated drawings.

### BRIEF DESCRIPTION OF THE DRAWINGS

FIG. 1 is a schematic diagram of an overview for an exemplary embodiment of an SMS messaging system;

FIG. 2 is a schematic diagram of an overview for a WAN/LAN system;

FIG. 3 is a schematic diagram for a computer used with a value added service provider;

FIG. 4 is a schematic diagram for a mobile device;

FIG. 5 is a schematic diagram of a system overview for an exemplary embodiment of the invention;

FIG. 6 is a schematic diagram for the flow of messages without session management;

FIG. 7 is a schematic diagram for the flow of messages with session management;

FIG. 8 is a schematic diagram for an entry in a database;

FIG. 9 is a flow chart of the actions performed to send a MT message with session management; and

FIG. 10 is a flow chart of the actions performed to send a MO message with session management.

### DETAILED DESCRIPTION OF THE PREFERRED EMBODIMENT

In the following detailed description of exemplary embodiments of the invention, reference is made to the accompanied drawings, which form a part hereof, and which is shown by way of illustration, specific exemplary embodiments of which the invention may be practiced. Each embodiment is described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims. Referring to the drawings, like numbers indicate like parts throughout the views. Additionally, a reference to the singular includes a reference to the plural unless otherwise stated or is inconsistent with the disclosure herein.

Briefly described, the invention provides a mechanism for enabling a user of a mobile device to reply to an SMS message without extensive hand coding. Generally, a VAS posts an XML (Extensible Markup Language) document to an SMS gateway (SMSG). The XML document includes a session key, i.e., Cookie, and an SMS message with the addresses for the mobile device and the VAS. The SMSG replaces the VAS's address in the SMS message with another address assigned to the gateway by a telephone carrier. The Cookie is stored in a database managed by the SMSG. Next, the modified SMS message is forwarded to the mobile device. The modified SMS message causes a menu to be displayed and/or enables the detection of an entered key word at the mobile device.

When a user replies to the modified SMS message (enters a key word or selects a menu item), an SMS message (reply) is generated at the mobile device and sent to the SMSG. The SMS reply includes text representing the entered keyword/selected menu item, a source address of the mobile device and a destination address that is assigned to the SMSG. The SMSG modifies the SMS reply by replacing the destination address assigned to the gateway with the VAS address previously stored in the database with the Cookie. Also, the SMSG adds the Cookie previously stored in the database and the modified SMS reply to an XML document that is provided to the VAS. The session information included in the Cookie and the keyword/selected item in the SMS reply are used by the VAS to interpret a user's response to the original SMS message. Thus, the invention enables a user to easily generate a reply to a previously received SMS message without extensive hand coding of descriptive text and a destination address.

Illustrative Operating Environment

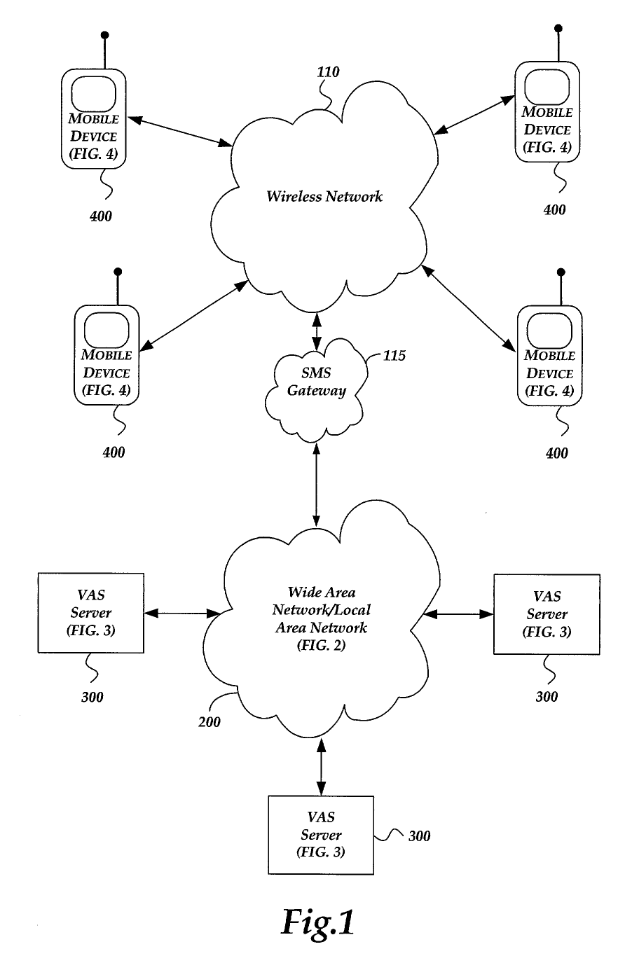

With reference to FIG. 1, an exemplary system includes wireless mobile devices 400, wireless network 204, SMS gateway 115, wide area network (WAN)/local area network (LAN) 200 and one or more servers 300 managed by a VAS.

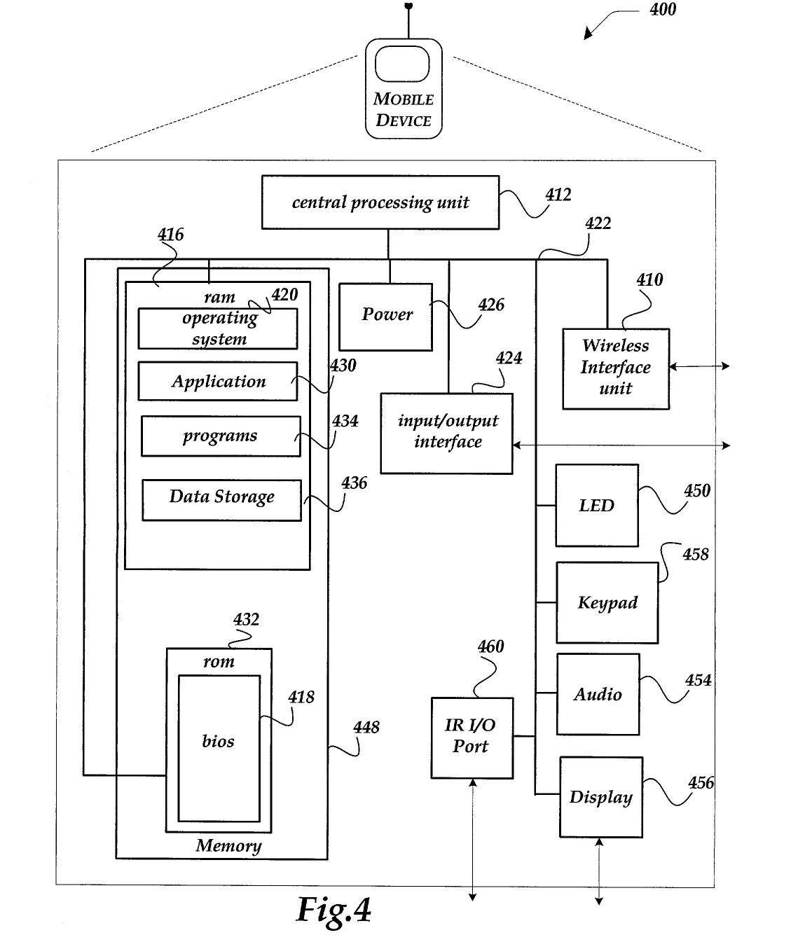

Mobile devices 400 are coupled to wireless network 204 and are described in more detail in conjunction with FIG. 4. Generally, mobile devices 400 include any device capable of connecting to wireless network 204. Such mobile devices include cellular telephones, smart phones, pagers, radio frequency (RF) devices, infrared (IR) devices, citizen band radios (CBs), integrated devices combining one or more of the preceding devices, and the like. Mobile devices 400 may also include other devices that have a wireless interface such as PDAs, handheld computers, personal computers, multiprocessor systems, microprocessor-based or programmable consumer electronics, network PCs, wearable computers, and the like.

Wireless network 204 transports information to and from mobile devices 400. Wireless network 204 may include several components including a mobile messaging center (not shown) and an SMS center (not shown) for handling SMS messages between mobile devices 400 and VAS servers 300. The mobile messaging center (MMC) enables communication to and from cell phones, pagers, and other mobile devices, and the wired telephone network carries communications to wired telephones, long-distance communication links, and the like.

Wireless network 204 is coupled to WAN/LAN 200 through SMSG 115 which routes SMS messages between wireless network 204 and VAS servers 300 coupled to WAN/LAN 200. In one embodiment, SMSG 115 translates SMS messages from mobile devices into XML documents that are sent to VAS servers 300 coupled to WAN/LAN 200. Also, SMSG 115 translates the contents of XML documents posted by VAS servers 300 into SMS messages that are forwarded to mobile devices 300.

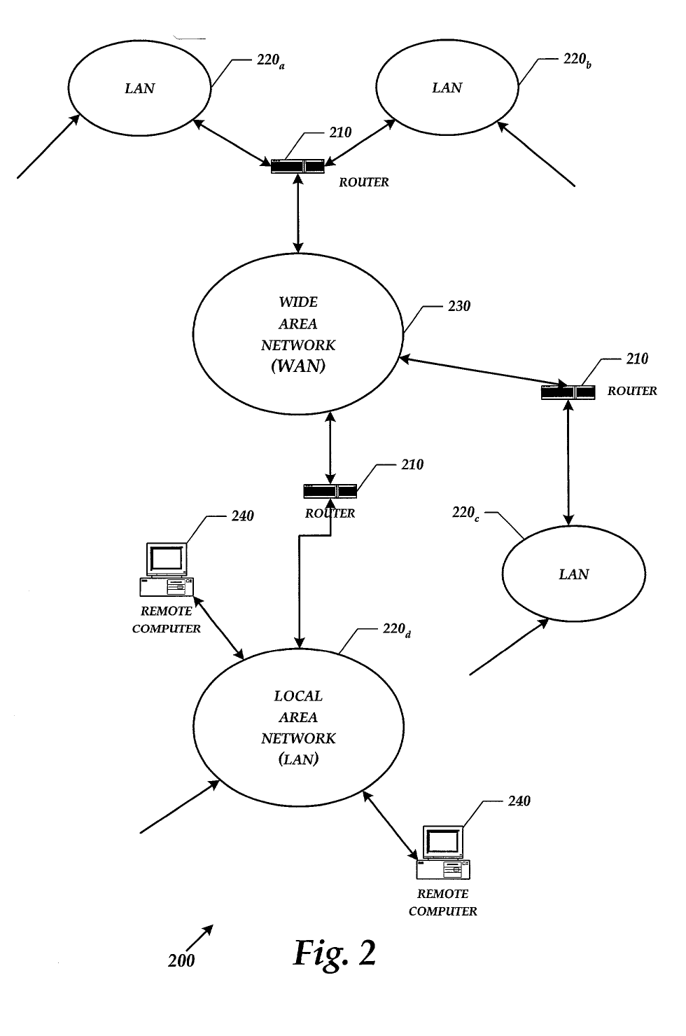

FIG. 2 shows WAN/LAN 200 in greater detail and illustrates a number of local area networks (“LANs”) 220_{a-d} and wide area network (“WAN”) 230 interconnected by routers 210. One example of WAN 230 is the Internet, which enables many computers to communicate over a host of gateways, routers, switches, hubs, and the like. An example of LAN 220 is a network used to connect computers in a single office. As shown, WAN 230 may be used to connect multiple LANs 220_{a-d}.

Routers 210 are intermediary devices on a communications network that expedite message delivery. On a single network linking many computers through a mesh of possible connections, a router receives transmitted messages and forwards them to their correct destinations over available routes. On an interconnected set of LANs—including those based on differing architectures and protocols—, a router acts as a link between LANs, enabling messages to be sent from one LAN to another.

Communication links within LANs typically include twisted wire pair, fiber optics, or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links, or other communications links known to those skilled in the art. Furthermore, computers, such as remote computer 240, and other related electronic devices can be remotely connected to either LANs 220_{a-d} or WAN 230 via a modem and temporary telephone link. The number of WANs, LANs, and routers in FIG. 2 may be increased or decreased without departing from the spirit or scope of this invention. As such, it will be appreciated that the Internet itself may be formed from a vast number of such interconnected networks, computers, and routers and that an embodiment of the invention could be practiced over the Internet without departing from the spirit and scope of the invention.

The media used to transmit information in communication links as described above illustrates one type of computer-readable media, namely communication media. Generally, computer-readable media includes any media that can be accessed by a computing device. Computer-readable media may include computer storage media, communication media, or any combination thereof. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, communication media includes wired media such as twisted pair, coaxial cable, fiber optics, wave guides, and other wired media and wireless media such as acoustic, RF, infrared, and other wireless media.

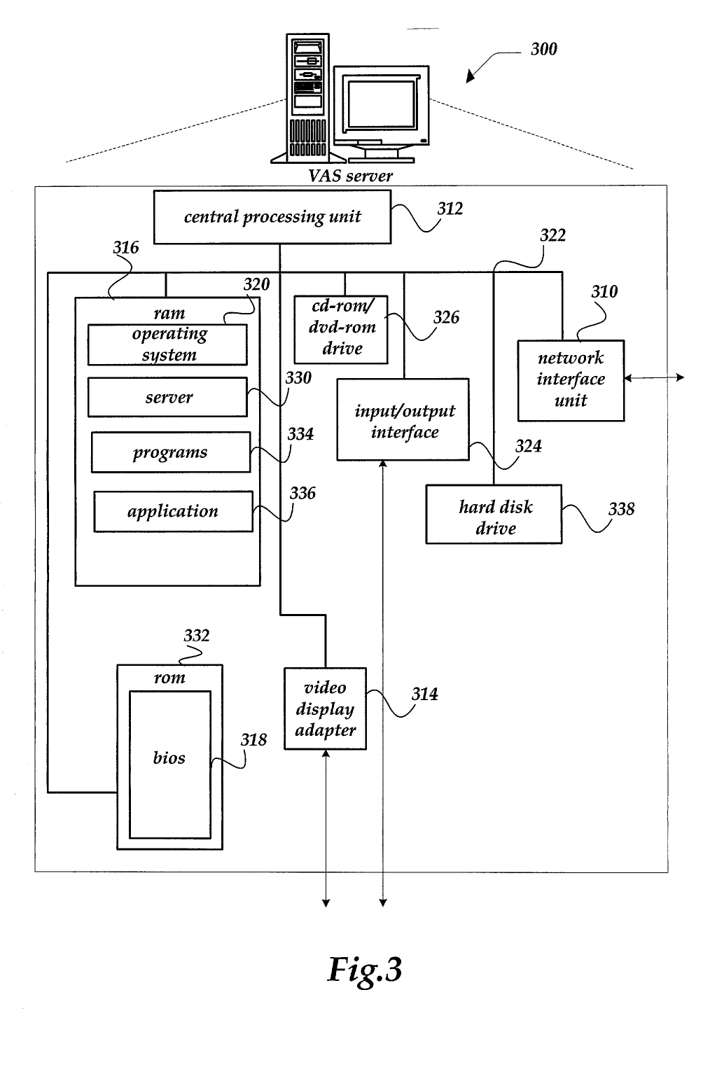

FIG. 3 shows an exemplary VAS server 300 that is operative to create, post and receive XML documents that include SMS messages for mobile devices. Those of ordinary skill in the art will appreciate that VAS server 300 may include many more components than those shown in FIG. 3. However, the components shown are sufficient to disclose an illustrative embodiment for practicing the present invention. As shown in FIG. 3, VAS server 300 is connected to WAN/LAN 200, or other communications network, via network interface unit 310. Those of ordinary skill in the art will appreciate that network interface unit 310 includes the necessary circuitry for connecting VAS server 300 to WAN/LAN 200, and is constructed for use with various communication protocols including the TCP/IP protocol. Typically, network interface unit 310 is a card contained within VAS server 300.

VAS server 300 also includes processing unit 312, video display adapter 314, and a mass memory, all connected via bus 322. The mass memory generally includes RAM 316, ROM 332, and one or more permanent mass storage devices, such as hard disk drive 328, a tape drive, CD-ROM/DVD-ROM drive 326, and/or a floppy disk drive. The mass memory stores operating system 320 for controlling the operation of VAS server 300. It will be appreciated that this component may comprise a general purpose server operating system as is known to those of ordinary skill in the art, such as UNIX, LINUX™, or Microsoft WINDOWS NT®. Basic input/output system (“BIOS”) 318 is also provided for controlling the low-level operation of VAS server 300.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data for creating, sending and receiving XML documents and SMS messages. More specifically, the mass memory stores applications including server application program 330 and programs 334. Server application program 330 includes computer executable instructions which, when executed by VAS server 300, generate XML documents, including the SMS messages described elsewhere in the specification. VAS server 300 may include a JAVA virtual machine, an SMTP handler application for transmitting and receiving email, an HTTP handler application for receiving and handing HTTP requests, JAVA applets for transmission to a browser executing on a client, and an HTTPS handler application for handling secure connections. The HTTPS handler application may be used for communication with external security applications (not shown), to send and receive private information in a secure fashion.

VAS server 300 also comprises input/output interface 324 for communicating with external devices, such as a mouse, keyboard, scanner, or other input devices not shown in FIG. 3. Likewise, VAS server 300 may further comprise additional mass storage facilities such as CD-ROM/DVD-ROM drive 326 and hard disk drive 328. Hard disk drive 328 is utilized by VAS server 300 to store, among other things, application programs, databases, and program data used by server application program 330. For example, customer databases, product databases, image databases, and relational databases may be stored. The operation and implementation of these databases is well known to those skilled in the art.

FIG. 4 shows an exemplary mobile device 400, according to one embodiment of the invention. Mobile device 400 may be arranged to wirelessly transmit and receive data. For instance, mobile device 400 may send and receive SMS text messages from other mobile devices (not shown) and VASs (See FIG. 3 and related discussion). The data communication may take place over the Internet, WAN/LAN 200, or some other communications network.

Mobile device 400 may include many more components than those shown in FIG. 4. However, the components shown are sufficient to disclose an illustrative embodiment for practicing the present invention. As shown in the figure, mobile device 400 includes processing unit 412, memory 448, RAM 416, ROM 432, operating system 420, application 430, programs 434, data storage 436, bios 418, power 426, input/output interface 424, wireless interface unit 410, LED 450, audio 454, display 456, keypad 458, and infrared input/output port(s) 460.

Mobile device 400 may connect to WAN/LAN 200, or other communications network, via wireless interface unit 410. Those of ordinary skill in the art will appreciate that wireless interface unit 410 includes the necessary circuitry for connecting mobile device 400 to WAN/LAN 200, and is constructed for use with various communication protocols including the TCP/IP, HTTP and WAP protocols. Wireless interface unit 410 may include a radio layer (not shown) that is arranged to transmit and receive radio frequency communications. Wireless interface unit 410 connects mobile device 400 to external devices, via a communications carrier or service provider.

Mass memory 448 generally includes RAM 416, ROM 432, and one or more data storage units 436. The mass memory stores operating system 420 for controlling the operation of mobile device 400. It will be appreciated that this component may comprise a general purpose server operating system as is known to those of ordinary skill in the art, such as a version of UNIX, LINUX™, or Microsoft WINDOWS®. Basic input/output system (“BIOS”) 418 is also provided for controlling the low-level operation of mobile device 400.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data used within mobile device 400. More specifically, the mass memory stores applications including the command button activation application 430, and programs 434. Programs 434 may include computer executable instructions which, when executed by mobile device 400, transmit and receive SMS messages, e-mail, audio, video, and the like. One or more programs 434 may be loaded into memory 448 and run under control of operating system 420. Examples of application programs include telephone programs, communication programs, productivity programs (word processing, spreadsheet, etc.), browser programs, and the like. Mobile computing device 400 also includes Rom 432. Rom 432 may be used to store data that should not be lost when mobile device 400 loses power.

Mobile device 400 also comprises input/output interface 424 for communicating with external devices, such as a headset, or other input or output devices not shown in FIG. 4. Data storage 436 is utilized by mobile device 400 to store, among other things, application programs, databases and data. For example, user databases, product databases, image databases, and relational databases may be stored with data storage 436.

Keypad 458 may be any input device arranged to receive inputs from a user. For example, keypad 458 may be a push button numeric dialing, or a keyboard. Display 456 may be a liquid crystal display, or any other type of display commonly used in mobile devices. Display 456 may also be a touch screen arranged to receive a users inputs. Display 456 may be capable of displaying text, icons, and symbols.

Power supply 426 provides power to mobile device 400. According to one embodiment, a rechargeable battery provides power. The power may be also be provided by an external power source, such as an AC adapter or a powered docking cradle that supplements or recharges the battery.

As shown, mobile device 400 can include light emitting diode (LED) display 450, audio interface 454, and infrared input/output port 460. LED display 450 may be controlled to remain active for specific periods or events. For example, an LED display may stay on while the phone is powered or may light up in various patterns. Audio interface 454 is arranged to receive and provide audio signals. For example, audio interface 454 may be coupled to a speaker (not shown) to provide audio from a telephone call, or from some other audio source. Audio interface 454 may also be coupled to an input device, such as a microphone, to receive audio input. Infrared input/output port 460 may be used to input/output data with another mobile device or fixed device such as a PDA (not shown).

System Overview

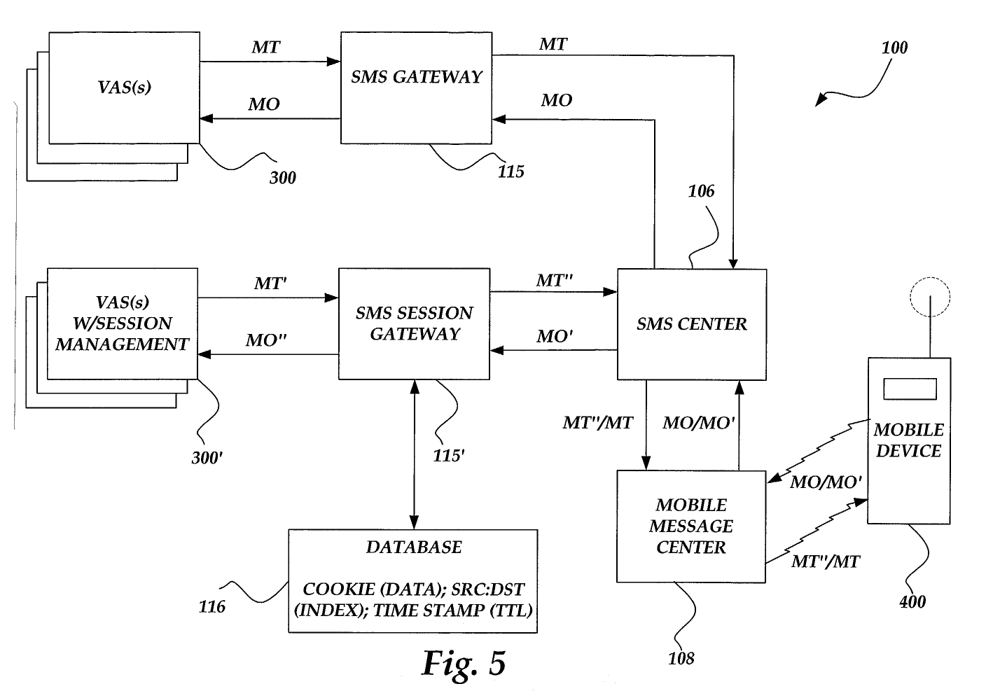

FIG. 5 shows a system overview 100 illustrating in greater detail an embodiment of the invention. Several VASs 300 (without SMS session management) are coupled to an SMS gateway (SMSG) 115, which is coupled to an SMS center (SMSC) 106. Several other VASs 300′ that support SMS session management are coupled to another SMSG 115′ which also supports SMS session management. SMSG 115′ is coupled to SMSC 106 and a mobile messaging center (MMC) 108 is coupled to the SMSC.

SMSG 115 and SMSG 115′ facilitate the communication of SMS messages between SMSC 106 and VAS 300 and VAS 300′, respectively. Also, SMSC 106 communicates SMS messages between MMC 108 and SMSG 115 or SMSG 115′. MMC 108 handles wireless broadcast communications with mobile device 400. Also, MMC 108 is in communication with SMSC 106 for handling SMS messages for mobile device 400. A database 116 is coupled to SMSG 115′ for storing information employed to manage a session of SMS messages between VAS 300′ and mobile device 400. Additionally, in one embodiment, a client-server architecture may be employed to implement the invention.

The flow of an SMS message from VAS 300 to mobile device 400 occurs as follows. From VAS 300, a mobile terminated SMS message (MT) for mobile device 400 is posted to SMSG 115, which forwards the MT message over a network to SMSC 106. SMSC 106 forwards the MT message to MMC 108 where it is wirelessly broadcast to mobile device 400. Typically, the content of the received MT message is displayed by mobile device 400.

The flow of a reply to an SMS message from VAS 300 generally occurs as follows. A reply is manually entered/coded at mobile device 400 (including the VAS destination address and state information), which is included in a mobile originated SMS message (MO). Mobile device 400 wirelessly broadcasts the MO message to MMC 108 where the MO message is forwarded to SMSC 106. The MO message is sent by SMSC 106 to SMSG 115. Next, SMSG 115 provides the MO message to VAS 300, which is identified by the destination address included in the message. It is understood that SMSC 106 “knows” where to send an MO message based on a previous association of the destination address with SMSG 115 by a telephone carrier.

The flow of an SMS message (with SMS session management) from VAS 300′ to mobile device 400 generally occurs as follows. From VAS 300′, a mobile terminated SMS message (MT′) with a session key, i.e., Cookie, is posted to SMSG 115′, where a modified SMS message (MT″) is generated. The Cookie can include information indicating the session and state of the MT′ message sent to mobile device 400. In the modified MT″ message, the Cookie and the source address of the originating VAS are removed and stored in database 116. Also, the source address of VAS 300′ is replaced in the modified MT″ message with a new source address that was previously associated with SMSG 115′ by a telephone carrier. Next, SMSG 115′ forwards the MT″ message to SMSC 106 where the MT″ message is forwarded to MMC 108 for wireless broadcast to mobile device 400. The content of the MT″ message can be displayed by mobile device 400 for a user.

The flow of a reply to an SMS message from VAS 300′ generally occurs as follows. A reply, i.e., mobile originated (MO′) message, is automatically generated based on the source and destination addresses in the MT″ message and either a key word that is entered or a selected menu item at mobile device 400. Mobile device 400 wirelessly broadcasts the MO′ message to MMC 108 where the message is forwarded to SMSC 106. The MO′ message includes a destination address that is substantially the same as the source address for the MT″ message provided to mobile device 400.

SMSC 106 sends the MO′ message to SMSG 115′ where the message is modified by replacing the destination address with the source address of the MT′ message previously stored in database 116. Also, the Cookie stored in the database is included in an XML document with the modified MO″ message. SMSG 115′ employs the “new” destination address to forward the XML document to VAS 300′. The contents of the Cookie and the MO″ message are employed by VAS 300′ to process the reply from mobile device 400.

Generally, a Cookie is a mechanism, which server side connections can use to both store and retrieve state information on the client side of the connection. Historically, this state object has been called a “Cookie,” for no compelling reason. The Cookie mechanism is a powerful tool that enables different types of application programs to be written for network-based environments. The addition of a simple, persistent, client-side state significantly extends the capabilities of network-based client/server application programs.

For example, the invention uses a Cookie that includes the state of a session of SMS messages between a client (mobile device) and a server; freeing the client from retyping a destination address and large amounts of descriptive text for each reply to an SMS message without session management capability. Also, the Cookie can include other information such as a session identifier and a uniform resource locator (URL) link to other information.

SMS Message Flow

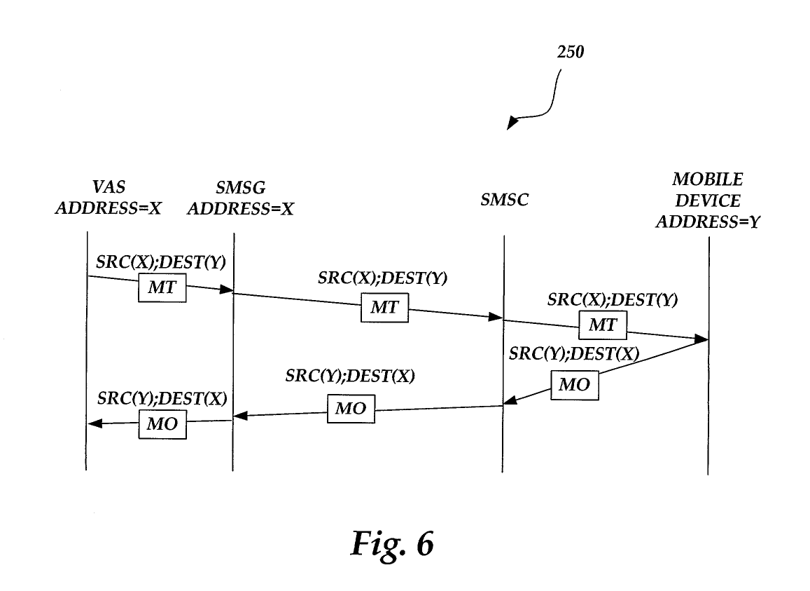

FIG. 6 illustrates a schematic overview 250 of the flow of SMS messages (both MO and MT) between a VAS (address “X”) without session management and a mobile device (address “Y”). Although the address of the mobile device is shown as “Y”, it is understood that the actual address of the mobile device is typically a telephone number, e.g., (206) 555-1212. Also, although the address of the VAS is shown as “X”, it may be a telephone number, service number or an IP address.

An MT message is sent by the VAS to an SMSG that is associated with the source address (“X”) and where the MT message will be forwarded to an SMSC. The MT message is sent by the SMSC to the mobile device with a source address (“X”) and a destination address (“Y”). The SMSC typically employs an MMC (not shown) to wirelessly broadcast the MT message to the mobile device, where the contents of the message are displayed for the user.

When the mobile device generates a reply to the MT message or an unrelated MO message for the VAS, the process is substantially the same. First, the content of the MO message is manually coded at the mobile device, including the destination address (“X”) and content (reply). The mobile device sends the MO message to an SMSC where the message is forwarded to an SMSG associated with the destination address (“X”) included in the message. Typically, the MO message is initially received by an MMC (not shown), which forwards the message to the SMSC. Next, the SMSG forwards the MO message to the destination address (“X”) included in the message for further processing by the VAS.

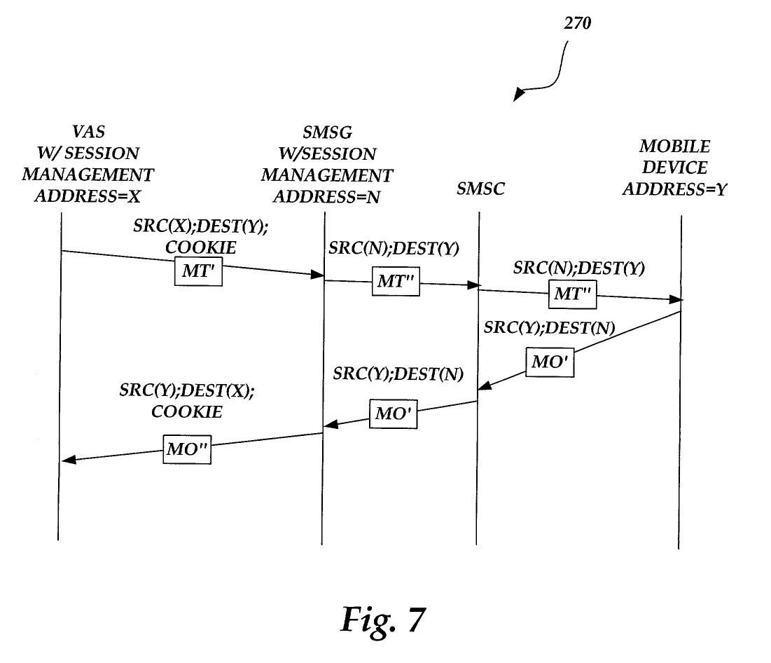

FIG. 7 illustrates a schematic overview 260 of the flow of SMS messages (both MO and MT) between a VAS with session management and a mobile device. First, an XML document that includes a MT′ message and a session key, e.g., a Cookie, is posted by the VAS to the SMSG. The MT′ message includes a source address of “X” and a destination address of “Y”. The SMSG stores the session key in a database for use at a later date. Also, the SMSG modifies the MT′ message by removing the source address of the VAS (“X”) and replacing it with a new source address (“N”) associated with the SMSG. A tuple that includes the new source address (“N”) and the destination address (“Y”) is stored in the database as an index and associated with the stored session key and the source address of the VAS. Next, the modified MT″ message is sent to the SMSC where the destination address (“Y”) is used to forward the message to the mobile device. The content of the MT″ message is displayed by the mobile device for the user.

The flow of a reply to an SMS message from VAS 300′ generally occurs as follows. When a user of the mobile device enters a reply to the MT″ message, an MO′ message is created and forwarded to the SMSC. The MO′ message includes a source address of “Y” and a destination address of “N”, which was the source address in the MT″ message. As discussed elsewhere, the “Y” address is associated with the mobile device and the “N” address is associated with the SMSG. Also, the MO′ message is typically broadcast by the mobile device to an MMC which forwards the message to the SMSC. The SMSC forwards the MO′ message to the SMSG that is associated with the destination address “N”.

At the SMSG, a tuple representing the source (“Y”) and destination (“N”) addresses included in the MO′ message is employed to identify a match with another tuple stored in the database managed by the SMSG. The other tuple represents the destination and source addresses originally included in the MT′ message. When a match is determined, the SMSG modifies the MO′ message by replacing the destination address “N” with a new destination address “X”. The SMSG creates an XML document that includes the modified MO″ message. The Cookie associated with the MT″ message and previously stored in the database is also included with the XML document. Next, the SMSG forwards the XML document to the VAS associated with the new destination address “X”.

Additionally, the VAS can employ the Cookie included with the XML document to identify the state of the reply from the mobile device. For example, when an MO″ message (reply) includes the word “buy”, the Cookie can be employed to determine the particular goods or services that were offered for sale in a previous MT″ message to a mobile device. It is also envisioned that users of instant messaging services may employ this invention to respond to news headlines, reply to an invitation and play games, such as chess.

Additionally, it is understood that the new source address in the modified MT″ message is one of a block of addresses assigned to the SMSG by the telephone carrier; and any address from this block can be chosen as a new source address by the invention. Also, these addresses can be a short service number, i.e., the new source address does not have to be an actual telephone number. An exemplary SMSG that utilizes the invention does not need a telephone carrier to associate it with large numbers of addresses that are individually associated with each SMS message. Instead, a much smaller number of addresses can be associated with the SMSG.

Generally, since a user tends not to have more than 15 SMS messaging sessions ongoing, an SMSG employing the invention may only need to be assigned a block of 15 addresses or less by a telephone carrier. This relatively small number of assigned addresses enables an SMSC to quickly/easily identify an SMSG with session management and route an MO′ message to the identified SMSG. Also, this aspect of the invention reduces the burden on telephone carriers because they do not have to assign millions of addresses to an SMSG to handle SMS messages between mobile devices and VASs.

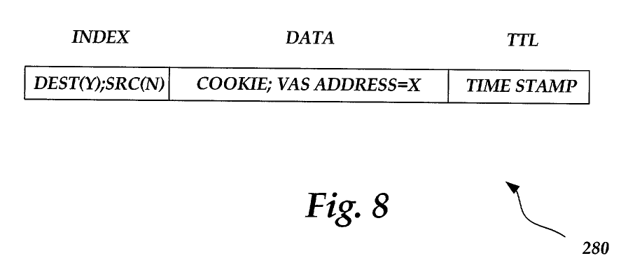

FIG. 8 shows an exemplary embodiment of an entry 280 in the database that is used by an SMSG with session management. The entry includes an index based on a tuple of a destination address of a mobile device “Y” and a source address (“N”) assigned to the SMSG. The entry references other data such as a Cookie and the source address (“X”) of the VAS that originally posted the MT message. Optionally, a time to live (TTL) field may be associated with the entry that includes a timestamp. When the timestamp is not fresh, a MO message is not forwarded to the VAS. Also, it is understood that the database entry could be adjusted to any arbitrary length to accommodate information included with the Cookie.

Further, the period of time for the timestamp could be selected by the VAS depending upon the type and expected freshness of the information included in the MT message sent to the mobile device. However, it is understood that the SMSG could also control the length of time associated with the timestamp and determine a maximum time limit. A daemon in the database could be employed to check the freshness of the timestamps for each entry. A typical length of time for a timestamp might be 10 minutes. However, an SMS message that includes a stock quote might have a timestamp that remains fresh for 10 hours.

Additionally, an SMSG with session management could keep logs for data mining metrics. For example, the metrics could be used to determine those power users that reply often or send out many SMS messages, user age and the type of SMS message that a particular user tends to respond to. In some cases, the SMSG could be configured to only bill users for SMS messages from a VAS that they reply to. In one embodiment, these metrics could be used to prevent a power user from receiving any unsolicited SMS messages from a VAS. In another embodiment, teenagers would get unsolicited SMS messages for free, which are actually billed to the advertisers (VASs). Although billing information is kept in call billing records (CBRs), the mechanism for billing is often unique for each VAS.

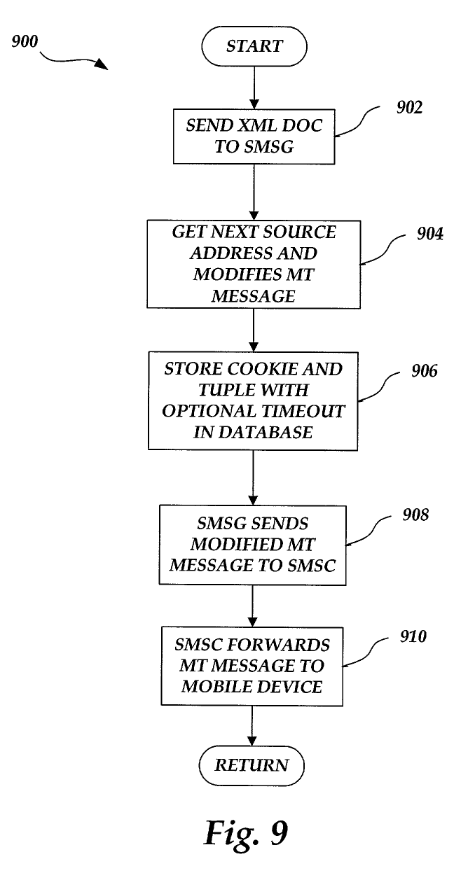

FIG. 9 is a flow chart 900 generally showing the actions for sending a MT message from a VAS with session management capability to a mobile device. Moving from a start block, the process moves to a block 902 where a VAS sends an XML document to an SMSG. The XML document includes a MT message and a Cookie. Advancing to a block 904, the SMSG performs the “Query: Get next source address” from a database. The SMSG modifies the MT message by replacing the source address with the next source address from a database of addresses, which were previously associated with the SMSG by a telephone carrier. Flowing to a block 906, the SMSG creates an entry in a database with a source:destination address tuple as the index and the Cookie as the data. Optionally, a timestamp may be stored with the Cookie in the database.

Moving to block 908, the SMSG send the modified MT message to an SMSC. The SMSC forwards the modified MT message in at least one protocol data unit (PDU) to the mobile device. An MMC may be employed to wirelessly broadcast the modified MT message to the mobile device. Next, the process returns to performing other actions.

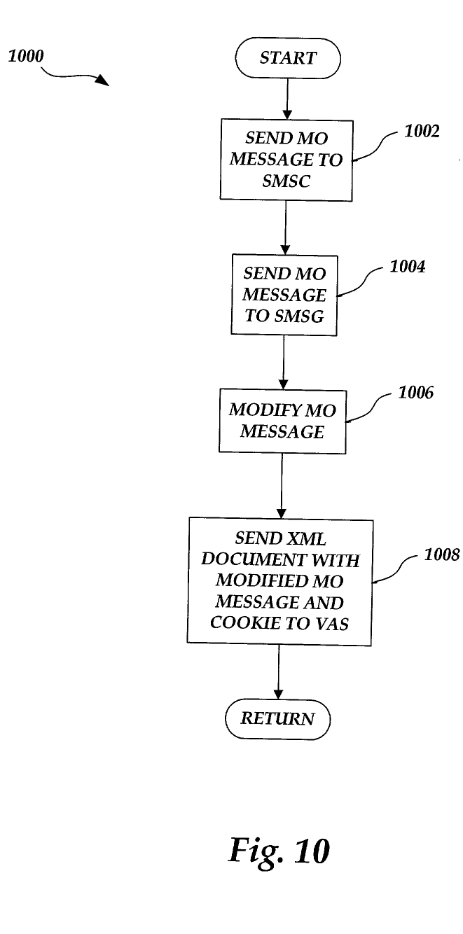

FIG. 10 is a flow chart 1000 generally illustrating the actions for sending an MO message from a mobile device to a VAS with session management capability. Moving from a start block, the process advances to a block 1002 where in reply to the MT message, the mobile device generates and sends a MO message to an SMSC. In some cases, an MMC will receive a wireless broadcast of the MO message and forward it to the SMSC. Also, the source address of the MT message is used as the destination address of the MO message. The MO message typically includes text representing a key word or selected menu item that was entered at the mobile device by the user.

At block 1004, the SMSC sends the MO message to an SMSG that was previously associated with the destination address by a telephone carrier. The SMSG compares the destination and source address tuple in the MO message to each source and destination address tuple stored as indexes in the database. When there is a match, the process advances to a block 1006 where the MO message is modified by replacing the destination address with the source address stored in the database as part of the “matched” index. Moving to a block 1008, the MO message and the Cookie associated with the matched index are included in an XML document that is forwarded to the VAS. Next, the process returns to performing other actions.

The above specification, examples and data provide a complete description of the manufacture and use of the composition of the invention. Since many embodiments of the invention can be made without departing from the spirit and scope camera of the invention, the invention resides in the claims hereinafter appended.

We claim:

1. A method for managing communication between a service provider and a mobile device, comprising:
(a) receiving a mobile terminated (MT) message and a session key from the service provider for the mobile device, the MT message including an address for the mobile device and an address for the service provider;
(b) modifying the MT message by replacing the service provider address with another address;
(c) sending the modified MT message to the mobile device;
(d) when the mobile device provides a mobile originated (MO) reply to the modified MT message, modifying the MO reply by replacing the other address with the address of the service provider that was included in the unmodified MT message; and
(e) sending the modified MO reply and the session key to the service provider, wherein the service provider processes the modified MO reply in relation to information included with the session key.

2. The method of claim 1, further comprising:
(a) storing the address of the service provider and the address of the mobile device as a tuple in a database;
(b) employing the other address and the address of the mobile device that are included in the mobile device's MO reply to access the tuple in the database; and
(c) employing the service provider's address associated with the tuple to modify the MO reply by replacing the other address with the address of the service provider.

3. The method of claim 2, further comprising:
(a) including a timestamp with the MT message sent by the service provider;
(b) associating the timestamp with the tuple in the database; and
(c) when the timestamp associated with the tuple is unexpired, enabling the service provider to receive the modified MO reply.

4. The method of claim 3, further comprising when the timestamp associated with a previous MT message is unexpired, modifying a subsequent MT message by replacing the address of the service provider with one of a plurality of addresses that are each different than the other address that was used to replace the service provider's address in the previous MT message.

5. The method of claim 4, wherein the plurality of addresses are associated with a gateway.

6. The method of claim 3, further comprising enabling the period of time associated with the time stamp to be selectable.

7. The method of claim 2, further comprising enabling the database to be managed by the gateway.

8. The method of claim 2, further comprising storing the session key in the database, the session key being associated with the tuple in the database.

9. The method of claim 8, wherein the session key is a Cookie that includes session information.

10. The method of claim 1, further comprising employing a short messaging service (SMS) protocol for each MT message and each MO reply sent between the service provider and the mobile device.

11. The method of claim 1, further comprising enabling a gateway to provide the other address that is employed to replace the address of the service provider in the modified MT message.

12. The method of claim 11, further comprising forwarding the modified MT message from the gateway to a messaging center that handles sending the modified MT message to the mobile device.

13. The method of claim 12, further comprising
(a) receiving the MO reply at a messaging center; and
(b) employing the other address that is included in the MO reply to identify a gateway; and
(c) sending the MO reply from the messaging center to the identified gateway.

14. The method of claim 1, further comprising:
(a) displaying a menu provided by the modified MT message with the mobile device; and
(b) when an item on the menu is selected, generating the MO reply.

15. The method of claim 1, further comprising
(a) displaying at least a portion of the modified MT message with the mobile device; and
(b) when a keyword is entered, generating the MO reply.

16. The method of claim 1, further comprising including the MO message and the session key in an XML data structure posted by the service provider.

17. A modulated data signal having executable actions for managing a communication session between a service provider and a mobile device, comprising:
(a) a transmitter for sending a session key and mobile terminated (MT) message from the service provider to the mobile device, the MT message including an address for the mobile device and an address for the service provider, wherein the MT message is modified by replacing the service provider address with another address and forwarded to the mobile device;
(b) a receiver for receiving the modified MT message that is forwarded to the mobile device; and
(c) a transcoder for enabling a modified mobile originated (MO) reply and session key to be sent to the service provider, wherein when the mobile device sends a MO reply to the modified MT message, the MO reply is modified by replacing the other address with the address of the service provider that was originally included in the unmodified MT message, and wherein the service provider processes the modified MO reply in relation to the information included with the session key.

18. A client-server system for managing communication between a service provider and a mobile device, comprising a server that performs actions, including:
(a) receiving a session key and a mobile terminated (MT) message from the service provider for the mobile device, the MT message including an address for the mobile device and an address for the service provider;
(b) modifying the MT message by replacing the service provider address with another address;
(c) sending the modified MT message to the mobile device;
(d) when the mobile device provides a mobile originated (MO) reply to the modified MT message, modifying the MO reply by replacing the other address with the address of the service provider that was included in the unmodified MT message; and
(e) sending the session key and the modified MO reply to the service provider, wherein the service provider processes the modified MO reply in relation to the information included with the session key.

19. A client-server system for managing communication between a service provider and a mobile device, comprising a client that performs actions, including:
(a) enabling a session key and mobile terminated (MT) message to be sent from the service provider to the mobile device, the MT message including an address for the mobile device and an address for the service provider, wherein the MT message is modified by replacing the service provider address with another address and forwarded to the mobile device;
(b) receiving the modified MT message that is forwarded to the mobile device; and
(c) enabling a modified mobile originated (MO) reply and session key to be sent to the service provider, wherein when the mobile device sends a MO reply to the modified MT message, the MO reply is modified by replacing the other address with the address of the service provider that was originally included in the unmodified MT message, and wherein the service provider processes the modified MO reply in relation to the information included with the session key.

20. A method for managing communication between a service provider and a mobile device, comprising:
(a) means for receiving a mobile terminated (MT) message and a session key from the service provider for the mobile device, the MT message including an address for the mobile device and an address for the service provider;
(b) means for modifying the MT message by replacing the service provider address with another address;
(c) means for sending the modified MT message to the mobile device;
(d) when the mobile device provides a mobile originated (MO) reply to the modified MT message, means for modifying the MO reply by replacing the other address with the address of the service provider that was included in the unmodified MT message; and
(e) means for sending the modified MO reply and the session key to the service provider, wherein the service provider processes the modified MO reply in relation to information included with the session key.
